(19) United States
(12) Patent Application Publication
(10) Pub. No.: US 2007/0237387 A1
(43) Pub. Date: Oct. 11, 2007

(54) Method for detecting humans in images

(76) Inventors: Shmuel Avidan, Brookline, MA (US); Qiang Zhu, Goleta, CA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/404,257

(22) Filed: Apr. 11, 2006

(51) Int. Cl. G06K 9/00

(52) U.S. Cl. 382/159; 382/103

(57) ABSTRACT

A method and system is presented for detecting humans in images of a scene acquired by a camera. Gradients of pixels in the image are determined and sorted into bins of a histogram. An integral image is stored for each bin of the histogram. Features are extracted fom the integral images, the extracted features corresponding to a subset of a substantially larger set of variably sized and randomly selected blocks of pixels in the test image. The features are applied to a cascaded classifier to determine whether the test image includes a human or not.

### FIELD OF THE INVENTION

This invention relates generally to computer vision and more particularly to detecting humans in images of a scene acquired by a camera.

### BACKGROUND OF THE INVENTION

It is relatively easy to detect human faces in a sequence of images of a scene acquired by a camera. However, detecting humans remains a difficult problem because of the wide variability in human appearance due to clothing, articulation and illumination conditions in the scene.

There are two main classes of methods for detecting humans using computer vision methods, see D. M. Gavrila, “The visual analysis of human movement: A survey,” Journal of Computer Vision and Image Understanding (CVIU), vol. 73, no. 1, pp. 82-98, 1999. One class of methods uses a parts-based analysis, while the other class uses single detection window analysis. Different features and different classifiers for the methods are known.

A parts-based method aims to deal with the great variability in human appearance due to body articulation. In that method, each part is detected separately and a human is detected when some or all of the parts are in a geometrically plausible configuration.

A pictorial structure method describes an object by its parts connected with springs. Each part is represented with Gaussian derivative filters of different scale and orientation, P. Felzenszwalb and D. Huttenlocher, “Pictorial structures for object recognition,” International Journal of Computer Vision (IJCV), vol. 61, no. 1, pp. 55-79, 2005.

Another method represents the parts as projections of straight cylinders, S. Ioffe and D. Forsyth, “Probabilistic methods for finding people,” International Journal of Computer Vision (IJCV), vol. 43, no. 1, pp. 45-68, 2001. They describe ways to incrementally assemble the parts into a full body assembly.

Another method represents parts as co-occurrences of local orientation features, K. Mikolajczyk, C. Schmid, and A. Zisserman, “Human detection based on a probabilistic assembly of robust part detectors,” European Conference on Computer Vision (ECCV), 2004. They detect features, then parts, and eventually humans are detected based on an assembly of parts.

Detection window approaches include a method that compares edge images to a data set using a chamfer distance, D. M. Gavrila and V. Philomin, “Real-time object detection for smart vehicles,” Conference on Computer Vision and Pattern Recognition (CVPR), 1999. Another method handles space-time information for moving-human detection, P. Viola, M. Jones, and D. Snow, “Detecting pedestrians using patterns of motion and appearance,” International Conference on Computer Vision (ICCV), 2003.

A third method uses a Haar-based representation combined with a polynomial support vector machine (SVM) classifier, C. Papageorgiou and T. Poggiom, “A trainable system for object detection,” International Journal of Computer Vision (IJCV), vol. 38, no. 1, pp. 15-33, 2000.

The Dalal & Triggs Method

Another window based method uses a dense grid of histograms of oriented gradients (HoGs), N. Dalal and B. Triggs, “Histograms of oriented gradients for human detection,” Conference on Computer Vision and Pattern Recognition (CVPR), 2005, incorporated herein by reference.

Dalal and Triggs compute histograms over blocks having a fixed size of 16×16 pixels to represent a detection window. That method detects humans using a linear SVM classifier. Also, that method is useful for object representation, D. Lowe, “Distinctive image features from scale-invariant key points,” International Journal of Computer Vision (IJCV), vol. 60, no. 2, pp. 91-110, 2004; K. Mikolajczyk, C. Schmid, and A. Zisserman, “Human detection based on a probabilistic assembly of robust part detectors,” European Conference on Computer Vision (ECCV), 2004; and J. M. S. Belongie and J. Puzicha, “Shape matching object recognition using shape contexts,” IEEE Transactions on Pattern Analysis and Machine Intelligence (PAMI), vol. 24, no. 24, pp. 509-522, 2002.

In the Dalal & Triggs method, each detection window is partitioned into cells of size 8×8 pixels and each group of 2×2 cells is integrated into a 16×16 block in a sliding fashion so that the blocks overlap with each other. Image features are extracted from the cells, and the features are sorted into a 9-bin histogram of gradients (HoG). Each window is represented by a concatenated vector of all the feature vectors of the cells. Thus, each block is represented by a 36-dimensional feature vector that is normalized to an L2 unit length. Each 64×128 detection window is represented by 7×15 blocks, giving a total of 3780 features per detection window. The features are used to train a linear SVM classifier.

The Dalal & Triggs method relies on the following components. The HoG is a basic building block. A dense grid of HoGs across the entire fixed size detection window provides a feature description of the detection window. Third, a L2 normalization step within each block emphasizes relative characteristics with respect to neighboring cells, as opposed to absolute values. They use a soft conventional linear SVM trained for object/non-object classification. A Gaussian kernel SVM slightly increases performance at the cost of a much higher run time.

Unfortunately, the blocks in the Dalal & Triggs method have a relatively small, fixed 16×16 pixel size. Thus, only local features can be detected in the detection window. They cannot detect the ‘big picture’ or global features.

Also, the Dalal & Triggs method can only process 320×240 pixel images at about one frame per second, even when a very sparse scanning methodology only evaluates about 800 detection windows per image. Therefore, the Dalal & Triggs method is inadequate for real-time applications.

Integral Histograms of Orientated Gradients

An integral image can be used for very fast evaluation of Haar-wavelet type features using what are known as rectangular filters, P. Viola and M. Jones, “Rapid object detection using a boosted cascade of simple features,” Conference on Computer Vision and Pattern Recognition (CVPR), 2001; and U.S. patent application Ser. No. 10/463,726, “Detecting Arbitrarily Oriented Objects in Images,” filed by Jones et al. on Jun. 17, 2003; both incorporated herein by reference.

An integral image can also be used to compute histograms over variable rectangular image regions, F. Porikli, “Integral histogram: A fast way to extract histograms in Cartesian spaces,” Conference on Computer Vision and Pattern Recognition (CVPR), 2005; and U.S. patent application Ser. No. 11/052,598, “Method for Extracting and Searching Integral Histograms of Data Samples,” filed by Porikli on Feb. 7, 2005; both incorporated herein by reference.

### SUMMARY OF THE INVENTION

A method and system according to one embodiment of the invention integrates a cascade of classifiers with features extracted from an integral image to achieve fast and accurate human detection. The features are HoGs of variable sized blocks. The HoG features express salient characteristics of humans. A subset of blocks is randomly selected from a large set of possible blocks. An AdaBoost technique is used for training the cascade of classifiers. The system can process images at rates of up to thirty frames per second, depending on a density in which the images are scanned, while maintaining accuracy similar to conventional methods.

### BRIEF DESCRIPTION OF THE DRAWINGS

FIG. 1 is a block diagram of a system and method for training a classifier, and for detecting a human in an image using the trained classifier; and

FIG. 2 is a flow diagram of a method for detecting a human in a test image according to an embodiment of the invention.

### DETAILED DESCRIPTION OF THE PREFERRED EMBODIMENTS

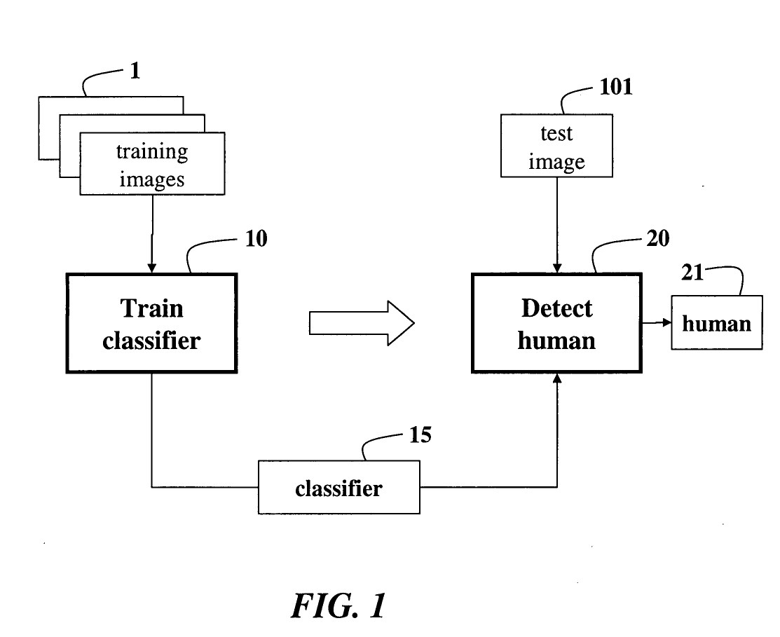

FIG. 1 is a block diagram of a system and method for training 10 a classifier 15 using a set of training images 1, and for detecting 20 a human 21 in one or more test images 101 using the trained classifier 15. The methodology for extracting features from the training images and the test images is the same. Because the training is performed in a one time preprocessing phase, the training is described later.

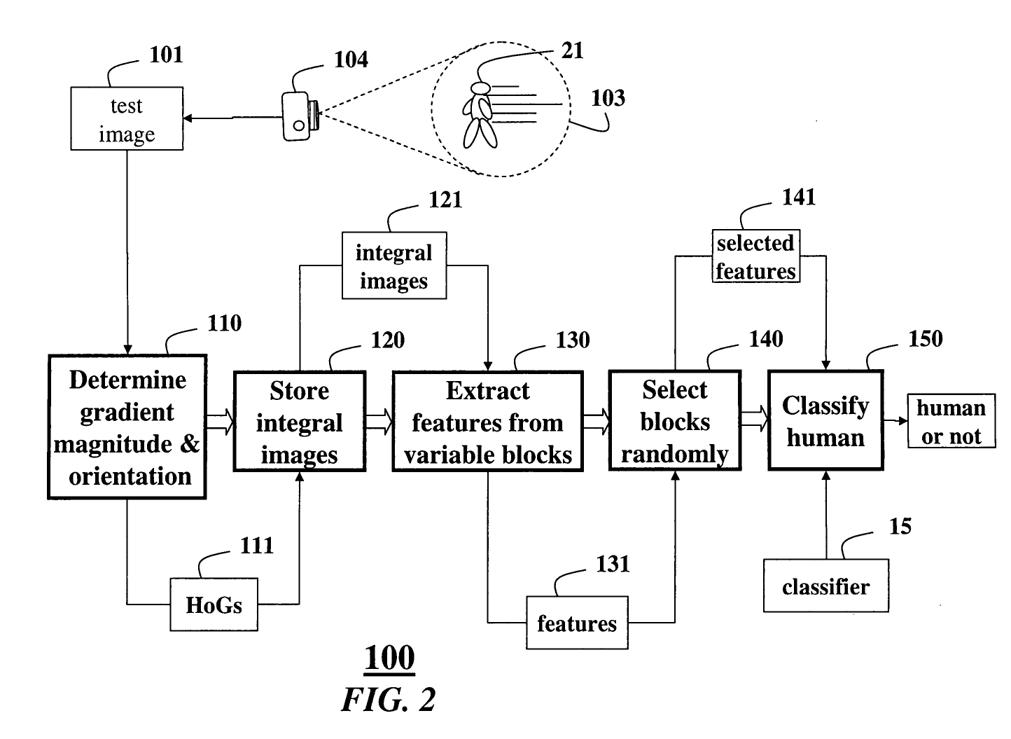

FIG. 2 shows the method 100 for detecting a human 21 in one or more test images 101 of a scene 103 acquired by a camera 104 according to an embodiment of our invention.

First, we determine 110 a gradient for each pixel. For each cell, we determine a weighted sum of orientations of the gradients of the pixels in the cell, where a weight is based on magnitudes of the gradients. The gradients are sorted into nine bins of a histogram of gradients (HoG) 111. We store 120 an integral image 121 for each bin of the HoG in a memory. This results in nine integral images for this embodiment of the invention. The integral images are used to efficiently extract 130 features 131, in terms of the HoGs, that effectively correspond to a subset of a substantially larger set of variably sized and randomly selected 140 rectangular regions (blocks of pixels) in the input image. The selected features 141 are then applied to the cascaded classifier 15 to determine 150 whether the test image 101 includes a human or not.

Our method 100 differs significantly from the method described by Dalal and Triggs. Dalal and Triggs use a Gaussian mask and tri-linear interpolation in constructing the HoG for each block. We cannot apply those techniques to an integral image. Dalal and Triggs use a L2 normalization step for each block. Instead, we use a L1 normalization. The L1 normalization is faster to compute for the integral image than the L2 normalization. The Dalal & Triggs method advocates using a single scale, i.e., blocks of a fixed size, namely, 16×16 pixels. They state that using multiple scales only marginally increases performance at the cost of greatly increasing the size of the descriptor. Because their blocks are relatively small, only local features can be detected. They also use a conventional soft SVM classifier. We use a cascade of strong classifiers, each composed of weak classifiers.

Variable Sized Blocks

Counter intuitively to the Dalal & Triggs method, we extract 130 features 131 from a large number of variable sized blocks using the integral image 121. Specifically, for a 64×128 detection window, we consider all blocks whose sizes range from 12×12 to 64×128. A ratio between block (rectangular region) width and block height can be any of the following ratios: 1:1, 1:2 and 2:1.

Moreover, we select a small step-size when sliding our detection window, which can be any of {4, 6, 8} pixels, depending on the block size, to obtain a dense grid of overlapping blocks. In total, 5031 variable sized blocks are defined in a 64×128 detection window, and each block is associated with a histogram in the form of a 36-dimensional vector 131 obtained by concatenating the nine orientation bins in four 2×2 sub-regions of the blocks.

We believe, in contrast with the Dalal & Triggs method, that a very large set of variable sized blocks is advantageous. First, for a specific object category, the useful patterns tend to spread over different scales. The conventional 105 fixed-size blocks of Dalal & Triggs only encode very limited local information. In contrast, we encode both local and global information. Second, some of the blocks in our much larger set of 5031 blocks can correspond to a semantic body part of a human, e.g., a limb or the torso. This makes it possible to detect humans in images much more efficiently. A small number of fixed-size blocks, as in the prior art, is less likely to establish such mappings. The HoG features we use are robust to local changes, while the variably sized blocks can capture the global picture. Another way to view our method is as an implicit way of doing parts-based detection using a detection window method.

Sampling Features

Evaluating the features for each of the very large number of possible blocks (5301) could be very time consuming. Therefore, we adapt a sampling method described by B. Scholkopf and A. Smola, “Learning with Kernels Support Vector Machines,” Regularization, Optimization and Beyond. MIT Press, Cambridge, Mass., 2002, incorporated herein by reference.

They state that one can find, with a high probability, a maximum of m random variables, i.e., feature vectors 131 in our case, in a small number of trials. More specifically, in order to obtain an estimate that is with probability 0.95 among the best 0.05 of all estimates, a random sub-sample of size log 0.05/log 0.95≈59 guarantees nearly as good performance as if all the random variables were considered. In a practical application, we select 140 randomly 250 features 141, i.e., about 5% of the 5031 available features. Then, the selected features 141 are classified 150, using the cascaded classifier 15, to detect 150 whether the test image(s) 101 includes a human or not.

Training the Cascade of Classifiers

The most informative parts, i.e., the blocks used for human classification, are selected using an AdaBoost process. Adaboost provides an effective learning process and strong bounds on generalized performance, see Freund et al., “A decision-theoretic generalization of on-line learning and an application to boosting,” Computational Learning Theory, Eurocolt '95, pages 23-37, Springer-Verlag, 1995; and Schapire et al., “Boosting the margin: A new explanation for the effectiveness of voting methods,” Proceedings of the Fourteenth International Conference on Machine Learning, 1997; both incorporated herein by reference.

We adapt a cascade as described by P. Viola et al. Instead of using relatively small rectangular filters, as in Viola et al., we use the 36-dimensional feature vectors, i.e. HoGs, associated with the variable sized blocks.

It should also be noted that, in the Viola et al. surveillance application, the detected humans are relatively small in the images and usually have a clear background, e.g., a road or a blank wall, etc. Their detection performance also greatly relies on available motion information. In contrast, we would like to detect humans in scenes with extremely complicated backgrounds and dramatic illumination changes, such pedestrians in an urban environment, without having access to motion information, e.g., a human in a single test image.

Our weak classifiers are separating hyperplanes determined from a linear SVM. The training of the cascade of classifiers is a one-time preprocess, so we do not consider performance of the training phase an issue. It should be noted that our cascade of classifiers is significantly different than the conventional soft linear SVM of the Dalal & Triggs method.

We train 10 the classifier 15 by extracting training features from the set of training images 1, as described above. For each serial stage of the cascade, we construct a strong classifier composed of a set of weak classifiers, the idea being that a large number of objects (regions) in the input images are rejected as quickly as possible. Thus, the early classifying stages can be called ‘rejectors.’

In our method, the weak classifiers are linear SVMs. In each stage of the cascade, we keep adding weak classifiers until a predetermined quality metric is met. The quality metric is in terms of a detection rate and false positive rate. The resulting cascade has about 18 stages of strong classifiers, and about 800 weak classifiers. It should be noted, that these numbers can vary depending on a desired accuracy and speed of the classification step.

The pseudo code for the training step is given in Appendix A. For training, we use the same training ‘INRIA’ data set of images as was used by Dalal and Triggs. Other data sets, such as the MIT pedestrian date set can also be used, A. Mohan, C. Papageorgiou, and T. Poggio, “Example-based object detection in images by components,” PAMI, vol. 23, no. 4, pp. 349-361, April 2001; and C. Papageorgiou and T. Poggio, “A trainable system for object detection,” IJCV, vol. 38, no. 1, pp. 15-33, 2000.

Surprisingly, we discover that the cascade we construct uses relatively large blocks in the initial stages, while smaller blocks are used in the later stages of the cascade.

### EFFECT OF THE INVENTION

The method for detecting humans in a static image integrates a cascade of classifiers with histograms of oriented gradient features. In addition, features are extracted from a very large set of blocks with variable sizes, locations and aspect ratios, about fifty times that of the conventional method. Remarkably, even with the large number of blocks, the method performs about seventy times faster than the conventional method. The system can process images at rates up to thirty frames per second, making our method suitable for real-time applications.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

APPENDIX A
Training the Cascade

| Input: | F_{target}: | target overall false positive rate |
|---|---|---|
| | fₘₐₓ: | maximum acceptable false positive rate per |
| | | cascade stage |
| | dₘᵢₙ: | minimum acceptable detections per cascade stage |
| | Pos: | set of positive samples |
| | Neg: | set of negative samples |

initialize: i = 0, Dᵢ = 1.0, Fᵢ = 1.0

| loop | Fᵢ > F_{target} |
|---|---|
| | i = i + 1 |
| | fᵢ = 1.0 |

loop fᵢ > fₘₐₓ

train 250 linear SVMs using Pos and Neg,
add the best SVM into the strong classifier,
update the weight in AdaBoost manner,
evaluate Pos and Neg by current strong classifier,
decrease threshold until dₘᵢₙ holds,
compute fᵢ under this threshold

loop end
Fᵢ₊₁ = Fᵢ × fᵢ
Dᵢ₊₁ = Dᵢ × dₘᵢₙ
Empty set Neg
if Fᵢ > F_{target}, then evaluate the current cascaded classifier
on the negative, i.e. non-human, images and add
misclassified samples into set Neg.

loop end

| Output: | An i-stage cascade, each stage having a boosted classifier of |
|---|---|
| | SVMs |
| | Final training accuracy: Fᵢ and Dᵢ |

I claim:

1. A method for detecting a human in a test image of a scene acquired by a camera, comprising the steps of:
determining a gradient for each pixel in the test image;
sorting the gradients into bins of a histogram;
storing an integral image for each bin of the histogram;
extracting features from the integral images, the extracted features corresponding to a subset of a substantially larger set of variably sized and randomly selected blocks of pixels in the test image; and
applying the features to a cascaded classifier to determine whether the test image includes a human or not.

2. The method of claim 1, in which the gradient is expressed in terms of a weighted orientation of the gradient, and a weight depends on a magnitude of the gradient.

3. The method of claim 1, in which ratios between widths and heights of the variable sized blocks are 1:1, 1:2 and 2:1.

4. The method of claim 1, in which the histogram has nine bins, and each bin is stored in a different integral image.

5. The method of claim 1, in which each feature is in a form of a 36-dimensional vector.

6. The method of claim 1, further comprising:
training the cascaded classifier, the training comprising:
performing the determining, sorting, storing, and extracting for a set of training images to obtain training features; and
using the training features to construct serial stages of the cascaded classifier.

7. The method of claim 6, in which each stage is a strong classifier composed of a set of weak classifiers.

8. The method of claim 7, in which each weak classifier is a separating hyperplane determined from a linear SVM.

9. The method of claim 6, in which the set of training images include positive samples and negative samples.

10. The method of claim 7, in which the weak classifiers are added to the cascaded classifier until a predefined quality metric is met.

11. The method of claim 10, in which the quality metric is in terms of a detection rate and a false positive rate.

12. The method of claim 6, in which the resulting cascaded classifier has about 18 stages of strong classifiers, and about 800 weak classifiers.

13. The method of claim 1, in which humans are detected in a sequence of images of the scene acquired in real-time.

14. A system for detecting a human in a test image of a scene acquired by a camera, comprising:
means for determining a gradient for each pixel in the test image;
means for sorting the gradients into bins of a histogram;
a memory configured to store an integral image for each bin of the histogram;
means for extracting features from the integral images, the extracted features corresponding to a subset of a substantially larger set of variably sized and randomly selected blocks of pixels in the test image; and
a cascaded classifier configured to determine whether the test image includes a human or not.
